(19) United States
(12) Patent Application Publication
(10) Pub. No.: US 2003/0230403 A1
(43) Pub. Date: Dec. 18, 2003

(54) Conductive thermal interface and compound

(76) Inventor: Brent J. Webb, Corvallis, OR (US)

Correspondence Address: Chernoff Vilhauer McClung & Stenzel, L.L.P., 1600 ODS Tower, 601 SW Second Avenue, Portland, OR, 97204-3157, US

(21) Appl. No.: 10/172,251

(22) Filed: Jun. 14, 2002

(51) Int. Cl. C09K 3/18; F28F 7/00

(52) U.S. Cl. 165/185; 165/80.3; 252/70

(57) ABSTRACT

Conduction of heat through an interface of a heat source and a heat sink is facilitated by a fluid metal thermal compound.

### CROSS-REFERENCE TO RELATED APPLICATIONS

Not applicable.

### BACKGROUND OF THE INVENTION

The present invention relates to conductive heat transfer and, more particularly, to a conductive thermal interface for a heat source and a heat sink and a thermal compound to facilitate heat transfer through the interface.

Improvements in semiconductors, both discrete, power semiconductors and integrated logic circuits (ICs), have resulted in smaller packages, faster speed, increased numbers of junctions, and increased heat generation. The temperature of semiconductor devices is managed by dissipating excess heat in the environment. Due to the small size of semiconductor packages and the substantial amount of heat generated within the package, it may be necessary to dissipate up to 800 watts/cm² of package surface to keep the semiconductor junctions in the package within acceptable temperature limits. In many applications, it is necessary to use a heat sink to sufficiently dissipate the heat generated by a semiconductor device. Typically, heat is conducted from the semiconductor junction in the device package to the exterior surface of the package, conducted across a thermal interface between the package and the heat sink, and then dissipated in the environment by a combination of radiation, conduction, and convection from the heat sink. In most semiconductor applications, heat is transferred from the heat sink to the environment by natural or forced convection of ambient air. However, the heat sink may be cooled by a liquid or by other means.

Typically, the thermal interface between a heat sink and a semiconductor heat source is formed by a clamping surface of the heat sink to a surface the package of the semiconductor device. Substantially all of the heat transferred in the interface is transferred by conduction. Unfortunately, no matter how well prepared, solid surfaces are never sufficiently flat or smooth to provide intimate contact over a large area. Referring to FIG. 1, all surfaces have a certain roughness comprising microscopic peaks 24 and valleys 26. In addition, macroscopic non-planarity, in the form of a concave 28 (indicated by a bracket), convex 30 (indicated by a bracket), or twisted surface, is typically superimposed on the surface roughness. As the surfaces of two objects, for example a heat source 20 and a heat sink 22, are brought together, only the peaks of the surfaces make physical contact. When surfaces of two typical electronic components are clamped together, less than one percent of the surfaces typically make physical contact while a layer of interstitial air separates the surfaces over the remainder of their coextensive area. Air has a very low thermal conductivity and heat is efficiently conducted only at the few points of surface contact. The heat transfer capacity of the thermal interface between a semiconductor device and a heat sink imposes a substantial limitation on the ability to maintain a safe operating temperature for the device.

A number of techniques have been developed to replace the interstitial air in a thermal interface with a more efficient conductor. Most of these techniques can be classified as one of either a solid metallurgical bond, a demountable liquid metal or grease interface, or a combination of these types. Examples of solid metallurgical bond interfaces are solders, gold-silicon eutectic bonds, or silver impregnated epoxies. A typical thermal resistance across an interface comprising these materials is approximately 0.2° K.-cm²/W depending on void fraction for the thermal joint and the characteristics of the interstitial material. While the thermal performance is generally good, this technique is unappealing because the thermal interface is difficult to design and repair and because assembly is complicated by the elevated temperatures required to form the solid metal bond.

Liquid metal interfaces retain the desirable low thermal resistance of a solid metallurgical interface while facilitating disassembly and repair of the interface. A liquid metal interface comprising an interstitial layer of liquefied gallium may have thermal impedance less than 0.05° K.-cm²/W which substantially is lower than available with other interface methods and materials. However, liquid metals are electrically conductive, can be toxic, and typically have a relatively low viscosity making handling and containment of the metal within the thermal joint important. Liquid metals tend to dissolve or amalgamate with many of the common metals used to fabricate wiring of printed circuit boards and integrated circuits and, if used incorrectly, may actually destroy the device that is being cooled. A complex thermal joint with barriers is required to retain the low viscosity liquid metal. For example, Spaight, U.S. Pat. No. 4,092,697, discloses a heat sink having a cavity in the underside to enclose an integrated circuit. A heat transfer fluid which may be a metal with a low melting temperature, such as solder, cesium, mercury, or gallium, is contained in a flexible membrane that is sealed to the underside of the cavity and trapped between the wall of the cavity and a surface of the enclosed IC. Moreover, liquid metals are typically characterized by high surface tension making it difficult to initiate and maintain good surface wetting that is critical to good thermal performance.

Thermal greases and grease-like materials are relatively easy to apply and can be used in conjunction with a simple, demountable thermal joint comprising contacting surfaces of a heat source and a heat sink. As a result, thermal greases and grease-like materials are commonly used to improve conduction of a thermal interface between a semiconductor heat source and a heat sink. Thermal greases are sufficiently fluid to displace much of the air in the microscopic voids in surfaces of the heat source and sink and since an interstice separates such a large portion of the coextensive surface area, the heat transfer rate of the interface can be substantially improved even though the conductivity of the grease is relatively low. Thermal greases, pastes, and similar materials are generally divided into electrically conductive and non-conductive materials. Non-conductive thermal greases typically include silicone and zinc thermal greases and generally have lower thermal conductivity (e.g., 1 W/m-° K.) than conductive thermal greases or metals used in thermal interfaces.

Conductive thermal greases or thermal pastes typically include particles of metal, such as silver, copper, and aluminum, and exhibit, generally, superior thermal performance to non-conductive greases. For example, a thermal paste comprising a mixture of 70% silver particles, boron nitride, and a suspension fluid is advertised as having a thermal resistance less than 0.0024° C.-in²/W. Conductive thermal greases provide relatively high thermal conductivity but thermal performance of the material is strongly correlated to the size and conductivity of the particles in the mixture. High performance conductive thermal pastes are relatively expensive because of the high cost of metal powders composed of extremely small particles with tightly controlled size tolerances.

While a number of techniques have been developed to improve the performance of a conductive thermal interface, the thermal interfaces can be costly, require complex joint design, and are often difficult to manufacture and repair. Further, the thermal performances available with many of these interfaces and techniques are marginal or inadequate to dissipate the heat of smaller, more powerful semiconductors. What is desired therefore, is a thermal interface that combines high thermal conductivity with simplicity of thermal joint design, low cost, and ease of use and repair.

### BRIEF DESCRIPTION OF THE DRAWINGS

FIG. 1 is a schematic illustration of a cross-section of contacting surfaces of a heat sink and a heat source.

FIG. 2 is an elevation view of a semiconductor package and a heat sink.

FIG. 3 is schematic cross-section of a thermal interface including a conductive thermal paste.

FIG. 4 is magnified, schematic perspective of a portion of a conductive thermal interface including a fluid metal thermal compound.

### DETAILED DESCRIPTION OF THE INVENTION

While the high performance thermal interface is described by reference to a semiconductor device and an associated heat sink, the thermal interface, heat transfer method, and thermal compound may be used with other known heat sources and sinks. Referring to FIG. 2, in a typical installation of a semiconductor device, such as a microprocessor, conductive projections from a surface of the device package 40 engage contacts of a socket 42 attached to a printed circuit board 44. The contacts of the socket 42 are electrically connected to metal traces of an electrical circuit printed on the circuit board 44. Heat is generated by semiconductor junctions that are housed within the device package 40 and is conducted to the surface of the device package. The device package 40 may include a heat slug of relatively high thermal conductivity or microstructural devices to aid in conducting heat from the interior of the package to its surface. Heat is transferred from the surfaces of the device package 42 to the surrounding air by a combination of radiation, convection, and conduction. However, due to the small size of the typical semiconductor device package 40 there is often insufficient surface area to permit dissipation of the substantial amount of heat generated within the package.

In many applications, a heat sink 46 is used to increase the rate of heat transfer from the heat source, device package 40, and protect the semiconductor junctions housed in the package. The heat sink 46 is a type intended to dissipate heat to the surrounding air and comprises generally a base 48 and a plurality of fins 50 projecting substantially normal to the base. The heat sink 46 is typically cast or extruded from a metal exhibiting good thermal conductivity, such as aluminum or copper. Heat is conducted from the surface of the device package 40 to the base 48 of the heat sink and then through the metal of the heat sink 46 to the fins 50. The fins 50 provide a large surface exposed to the ambient air and heat is transferred from fins 50 to the air, primarily by convection. The flow of air may be natural or forced by a fan. While the exemplary heat sink 46 is a type intended to dissipate heat in the surrounding air, liquid cooled heat sinks and heat sinks cooled by other mechanisms are also known.

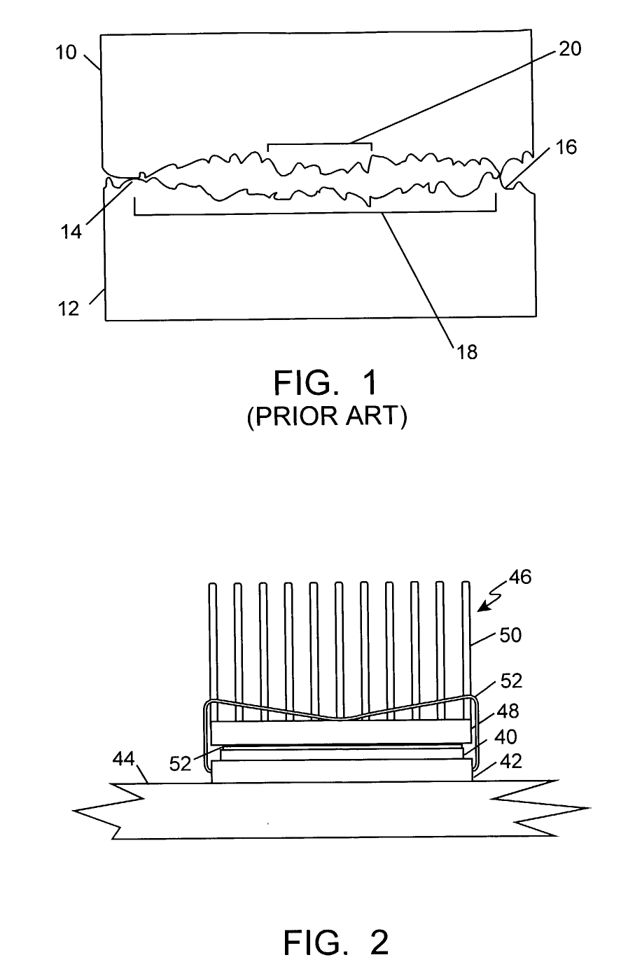

Heat sinks that are used to cool semiconductor devices commonly include a surface that is pressed into intimate contact with a surface of the device package. Heat is transferred from the surface of the device package 40 to the base 48 of the heat sink 46 primarily by conduction. A spring loaded clamp 52 exerts a force on the base 48 of the heat sink 46 to restrain the heat sink to the device package 40 and maintain pressure on the contacting surfaces that form thermal joint. However, when the surfaces of a typical heat sink and a typical device package are clamped together less than one percent of the coextensive surface area it typically in physical contact. Referring to FIG. 1, no matter how well prepared, all surfaces have a certain roughness comprising microscopic peaks 24 and valleys 28. In addition, surfaces are characterized by macroscopic non-planarity in the form of concavity 28 (indicated by a bracket), convexity 30 (indicated by a bracket), or twisting that is superimposed on the surface roughness. Areas of the surfaces that are not in contact are separated by an interstitial layer of air which has low thermal conductivity. Since the portion of the surface separated by air tends to be very large and the thermal conductivity of the air is low, the heat transfer capacity of the thermal interface formed by the contacting surfaces of the heat sink 10 and the heat source 12 (e.g., device package 40) may limit the ability to maintain the heat source within acceptable temperature limits.

Heat is transferred across the thermal interface from the heat source, device package 40, to the heat sink 46 primarily by conduction. The rate of heat transfer or conductance of a thermal joint comprising two rough surfaces can generally be modeled as:

Hⱼ=H_{c}+H_{g}

where: Hⱼ=conductance of the thermal interface

H_{c}=conductance of the contacting portion of the thermal joint

H_{g}=conductance of the non-contacting portion of the thermal joint.

The conductance of the contacting portion of the thermal joint is generally a function of the harmonic mean thermal conductivity of the heat transfer surface materials, the contact pressure of the contacting surfaces, and the surface microhardness of the softer of the two contacting materials. On the other hand, the conductance between two plane surfaces separated by an interstice can be generally expressed by:

$${H}_{g} = \frac{Q}{t} = \frac{kA ( {T}_{hot} - {T}_{cold} )}{d}$$

where: Q=heat transferred in time (t)

k=thermal conductivity of the interstitial material

A=effective coextensive area of the interstice surfaces

T^{hot}=temperature of the hot surface

T^{cold}=temperature of the cold surface

d=effective thickness of the interstitial material

For bare surfaces, the interstitial material is typically air which has a thermal conductivity of approximately 0.026 W/m-° K. The effective thickness of the interstitial material in a thermal joint with bare surfaces is function of the surface roughness of the contacting surfaces of the heat source and sink. An exemplary thermal joint comprising bare surfaces of an exemplary semiconductor device package and heat sink has been measured to have an effective thickness or bond line of 1.3×10⁻⁴ inches.

The conductance of a thermal joint can be significantly improved by applying a thermal grease or other interstitial thermal compound 52 to the gap between the contacting surfaces of the heat source and heat sink. The thermal grease behaves like a fluid and displaces the air in the interstice. A non-(electrically) conductive thermal grease, such as silicone grease, produces a marginal increase the effective thickness of the interstice. When treated with silicone grease, the exemplary thermal joint, referred to above, has a measured bond line or effective interstice thickness of 2×10⁻³ inches. As a result, even though the thermal conductivity of a non-conductive thermal grease is not particularly high (0.20 W/m-° K. and 0.7 W/m-° K.), the conductance of the interface is significantly improved, often by as much as an order of magnitude.

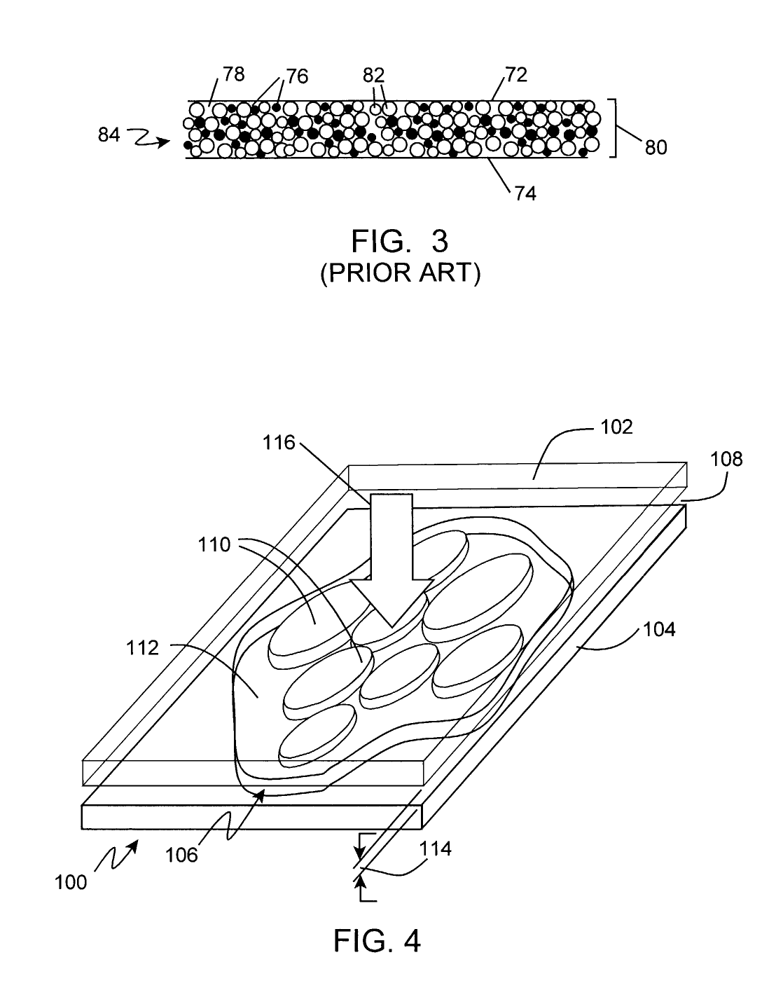

Further improvement in the thermal performance of conductive thermal interfaces has been obtained by adding highly conductive particles of a metal or ceramic to a thermal grease. The thermal conductivity of these thermal pastes is typically between 1.68 W/m-° K. and 2.58 W/m-° K., but one such thermal paste comprising approximately 70% silver particles, by weight, in a suspension fluid is advertised as having a thermal conductivity in excess of 9.0 W/m-° K. However, the performance of a thermal paste is limited by a characteristically long effective thickness or bond line of the layer of interstitial paste 52. Referring to FIG. 3, a thermal paste 70 displaces most of the interstitial air between the surfaces of a heat source 72 and a heat sink 74, although some microscopic pockets of air 76 may be entrained in the grease-like suspension material 78. The cross-section of the interstice 80 (indicated by a bracket) between the heat transfer surfaces 72, 74 is substantially occupied by particles 82 of the conductive material that are included in the mixture 84. However, friction between the individual particles and the limited pressure exerted on the heat transfer surfaces 72, 74 cause stacks of particles to bridge the gap 80. While the thermal conductivity of the particles is high, the effective thickness of the interstitial material is typically substantially greater for pastes comprising metal particles than for either bare surfaces or typical non-conductive thermal greases. The effective thickness of the interstitial thermal paste 84 is typically determined by the sizes and shapes of particles of conductive material in the paste. For example, an exemplary semiconductor to heat sink thermal joint may have an effective thickness of 6×10⁻³ inches when treated with a highly conductive metal-bearing thermal paste. Therefore, even though the thermal conductivity of the interstitial material is substantially increased, the thermal performance of the interface is limited by the significantly longer effective thickness or bond line of the interstitial thermal paste.

The present inventor concluded that further improving the thermal conductivity of an interstitial thermal paste would be expensive and only marginally improve the conductance of the thermal interface because metal particles used in thermal pastes have very high thermal conductivity, high metal content in the paste typically increases the effective thickness of the interstitial material, and powders of microscope metal particles with tightly controlled size tolerances are expensive. The inventor concluded that if the interstitial air was displaced by a liquid with high thermal conductivity, the effective thickness of the interstitial material or bond line could be minimized and the thermal performance of the interface maximized. The inventor concluded that a metal with a melting point at or below an operating temperature of the interface would provide high thermal conductivity combined with a minimal bond line.

The thermal compound of the present invention comprises a suspension fluid entraining particles of a metal having a melting point at or below the typical operating temperature of the thermal interface. The thermal compound can be applied to the heat transfer surfaces of a heat source and a heat sink in the same manner as a thermal grease or paste. When applied to the surfaces of the thermal interface, the thermal compound acts as fluid to displace the interstitial air. Referring to FIG. 4, in the high performance conductive thermal interface 100 heat generated by the heat source 104 causes the metal entrained in the fluid metal thermal compound 106 to melt. The metal entrained in the thermal compound is transformed to platelets 110 of liquefied metal within the suspension fluid 112. A force 116 applied to at least one of the heat source and heat sink 102 (illustrated as a transparent plate) by an actuator, such as clamp 52, urges relative displacement of the heat sink and heat source to minimize the effective thickness of the liquid thermal compound and maintain intimate contact between the thermal compound and the surfaces of the heat sink and source. Since the thermal compound is a liquid at the operating temperature of the thermal interface, the bond line or effective thickness of the interstitial material 114 between the heat transfer surfaces is minimized increasing the conductance of the interface.

While other metals, for example mercury, with melting temperatures at or below the maximum permitted temperature of the interface could be used, gallium is well suited because it has high thermal conductivity, a low melting temperature (30° C. (85° F.)), and is generally nonionic. Gallium does react unfavorably with aluminum which is commonly used for heat sinks, but anodizing provides adequate protection for aluminum in contact with a fluid metal thermal fluid containing gallium.

However, gallium, and most metals with low melting temperatures, have relatively low viscosity and tend to run readily. To restrain the liquid metal in the joint, the metal is mixed with a suspension fluid 112. The suspension fluid may be a silicone-based or non-silicone-based oil or grease. A suspension fluid with a viscosity in a range of 60,000-100,000 centipoises has been found to have sufficient viscosity to retain the liquefied gallium in the thermal joint at the operating temperature of a typical semiconductor device and adequate fluidity to effectively displace the interstitial air. Fluid metal thermal compounds comprising a mixture of 39-69% gallium by weight and, correspondingly, 59-29% suspension fluid, by weight have been found to combine high thermal conductivity with sufficient viscosity to be effectively retained in the thermal interface. Mixtures with higher concentrations of gallium have lower viscosity and are more difficult to retain in the thermal joint. The entrained metal will not stay in suspension in the suspension thermal compound at higher concentrations of the suspension fluid and if too little suspension fluid is included in the compound, the compound will not flow adequately.

Gallium, and other low melting temperature metals, exhibit relatively high surface tension and will not readily mix with fluids useful as suspension fluids. To enable suspension of the gallium in the suspension fluid, the fluid metal thermal compound includes a surfactant to reduce the surface tension of the gallium and the suspension fluid. While a number of known surfactants might be used, Jet Dry® automatic dishwasher rinse agent, produced by Ecolab Inc., St Paul, Minn. has been found to be suitable as a surfactant. Typically, the mixture comprises less than one percent rinse agent, by weight. Greater proportions of surfactant may reduce the viscosity of the mixture to an undesirable degree affecting retention in the thermal joint.

An antioxidant can be added to the thermal compound to prevent air dissolved in the compound during mixing from forming bubbles which would reduce the thermal conductivity of the compound. The antioxidant also absorbs air that may be trapped in the grain boundaries of metal surfaces of the heat sink 102 and heat source 104 which may not be displaced when the thermal compound is initially applied. Less than one percent antioxidant, by weight, is typically incorporated in the fluid metal thermal compound.

Combined with the elimination of air in the thermal interface, good surface wetting is desirable to maximize the heat transfer efficiency of the interface. To improve the surface wetting of the heat source and heat sink surfaces, a wetting agent can be added to the mixture. Gallium sesquioxide comprising 10-20%, by weight, of the thermal compound is a suitable wetting agent. When gallium sesquioxide is included as a wetting agent, the remainder of the thermal compound typically comprises 35-65% gallium; correspondingly, 8-48% suspension fluid; and less than one percent each surfactant and antioxidant.

The fluid metal thermal compound of the present invention comprises a liquid at the operating temperature of the high performance thermal interface and combines high thermal conductivity with minimal bond line thickness to achieve the high thermal conductance required by intense heat sources, such as modern semiconductor devices. An exemplary high performance thermal interface comprising a thermal compound of gallium and a suspension fluid was found to have a bond line of 1×10⁻³ inch and a thermal resistance approximately 33% less than an interface comprising a high performance thermal paste.

The detailed description, above, sets forth numerous specific details to provide a thorough understanding of the present invention. However, those skilled in the art will appreciate that the present invention may be practiced without these specific details. In other instances, well known methods, procedures, components, and circuitry have not been described in detail to avoid obscuring the present invention.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

The invention claimed is:

1. A thermal compound to facilitate conduction of thermal energy in an interface of a heat source and a heat sink, said thermal compound comprising:
(a) a suspension fluid; and
(b) a metal having a melting temperature less than a temperature of said interface.

2. The thermal compound of claim 1 wherein said suspension fluid comprises a silicone-based fluid.

3. The thermal compound of claim 1 wherein said suspension fluid comprises a fluid having a base other than silicone.

4. The thermal compound of claim 1 wherein said suspension fluid has a viscosity greater than 60,000 centipoises and less than 100,000 centipoises.

5. The thermal compound of claim 1 wherein said suspension fluid comprises more than 30 percent of a weight of said thermal compound and less than 60 percent of said weight of said thermal compound.

6. The thermal compound of claim 1 wherein said metal having a melting temperature less than a temperature of said interface comprises gallium.

7. The thermal compound of claim 1 wherein said metal having a melting temperature less than a temperature of said interface comprises more than 30 percent of a weight of said thermal compound and less than 60 percent of said weight of said compound.

8. The thermal compound of claim 1 further comprising a surfactant to reduce a surface tension of at least one of said metal and said suspension fluid.

9. The thermal compound of claim 8 wherein said suspension fluid has a viscosity greater than 60,000 centipoises and less than 100,000 centipoises.

10. The thermal compound of claim 8 wherein said metal having a melting point less than a temperature of said interface comprises gallium.

11. The thermal compound of claim 8 wherein said metal having a melting temperature less than a temperature of said interface comprises more than 30 of a weight of said thermal compound and less than 60 percent of said weight of said compound.

12. The thermal compound of claim 8 wherein said surfactant comprises less than one percent of a weight of said thermal compound.

13. The thermal compound of claim 1 further comprising an antioxidant.

14. The thermal compound of claim 13 wherein said antioxidant comprises less than one percent of a weight of said thermal compound.

15. The thermal compound of claim 1 further comprising a wetting agent.

16. The thermal compound of claim 15 wherein said wetting agent comprises gallium sesquioxide.

17. The thermal compound of claim 15 wherein said wetting agent comprises more than 10 percent of a weight of said thermal compound and less than 20 percent of said weight of said thermal compound.

18. A conductive thermal interface comprising:
(a) a heat source including a heat source surface;
(b) a heat sink including a heat sink surface arranged coextensive with said heat source surface and separated therefrom by an interstice;
(c) a thermal compound comprising a metal having a melting temperature less than a temperature of said interstice and a suspension fluid, said thermal compound being disposed in said interstice; and
(d) an actuator applying a force to urge displacement of at least one of said heat source surface and said heat sink surface to maintain intimate contact of said thermal compound with said heat source surface and said heat sink surface.

19. The thermal interface of claim 18 wherein said thermal compound comprises a suspension fluid having a viscosity greater than 60,000 centipoises and less than 100,000 centipoises.

20. The thermal interface of claim 18 wherein said metal having a melting temperature less than a temperature of said interstice included in said thermal compound comprises gallium.

21. The thermal interface of claim 18 wherein said metal having a melting temperature less than a temperature of said interstice comprises more than 30 percent of a weight of said thermal compound and less than 60 percent of said weight of said thermal compound.

22. The thermal interface of claim 18 wherein said thermal compound further comprises a surfactant to reduce a surface tension of at least one of said metal and said suspension fluid.

23. The thermal interface of claim 18 wherein said thermal compound further comprises an antioxidant.

24. The thermal interface of claim 23 wherein said antioxidant comprises less than one percent of a weight of said thermal compound.

25. The thermal interface of claim 18 wherein said thermal compound further comprising a wetting agent.

26. The thermal interface of claim 18 wherein said thermal compound further comprises gallium sesquioxide.

27. A method of conducting heat from a heat source having a heat source surface to a heat sink having a heat sink surface coextensive to said heat source surface and separated therefrom by an interstice, said method comprising the steps of:
(a) disposing a thermal compound in said interstice, said thermal compound comprising a suspension fluid and a metal having a melting temperature less than a temperature of said interstice; and
(b) applying a force to urge a displacement of at least one of said heat source surface and said heat sink surface to maintain intimate contact of said thermal compound with said heat source and said heat sink surfaces.

28. The method of claim 27 wherein said thermal compound disposed in said interstice comprises a suspension fluid having a viscosity greater than 60,000 centipoises and less than 100,000 centipoises.

29. The method of claim 27 wherein said metal having a melting temperature less than a temperature of said interstice included in said thermal compound disposed in said interstice comprises gallium.

30. The method of claim 27 wherein said metal having a melting temperature less than a temperature of said interstice comprises more than 30 percent of a weight of said thermal compound and less than 60 percent of said weight of said thermal compound disposed in said interstice.

31. The method of claim 27 wherein further comprising the step of including in said thermal compound disposed in said interstice a surfactant to reduce a surface tension of at least one of said metal and said suspension fluid.

32. The thermal interface of claim 31 wherein said surfactant comprises less than one percent of a weight of said thermal compound.

33. The method of claim 27 wherein further comprising the step of including an antioxidant in said thermal compound disposed in said interstice.

34. The thermal interface of claim 33 wherein said antioxidant comprises less than one percent of a weight of said thermal compound.

35. The method of claim 27 wherein further comprising the step of including a wetting agent in said thermal compound disposed in said interstice.

36. The thermal interface of claim 35 wherein said wetting agent comprises gallium sesquioxide.
